(19) United States
(12) Patent Application Publication
(10) Pub. No.: US 2006/0235094 A1
(43) Pub. Date: Oct. 19, 2006

(54) Uses of a method for the manufacture of foamed shaped polymer parts of liquid silicone rubber

(76) Inventor: Sasan Habibi-Naini, Rikon (CH)

Correspondence Address: Francis C. Hand, Esq.;c/o Carella Byme, Bain, Gilfillan, Cecchi,, Stewart & Olstein, 5 Becker Farm Road, Roseland, NJ, 07068, US

(21) Appl. No.: 11/403,712

(22) Filed: Apr. 13, 2006

(30) Foreign Application Priority Data
Apr. 19, 2005 (EP) 05405300.4

(51) Int. Cl. C08J 9/00

(52) U.S. Cl. 521/50

(57) ABSTRACT

A liquid silicone rubber molding composition (LSR) in the form of two separate components (A, B) is conveyed separately in two streams under elevated pressure and impregnated with an expanding agent (C). Thereafter, the two streams are mixed together under elevated pressure and then, while reducing the pressure, the reactive mixture is injected into a heated cavity of a shape-giving tool in which the molding composition is simultaneously foamed with a cross-linking reaction. The shaped polymer part that is manufactured has a degree of foaming of from 5 to 70% by volume and/or a Shore A hardness reduced by at least 10% in relation to a shaped polymer part of non-foamed LSR the polymer part may be formed in accordance with its end use purpose.

This invention relates to uses of a method for the manufacture of foamed shaped polymer parts of liquid silicone rubber. More particularly, this invention relates to a method of making foamed shaped polymer parts of liquid silicone rubber and the parts made thereby.

The term “LSR” is used in the following for liquid silicone rubber.

LSR is a two component polymer system, the components of which are not reactive individually and which is offered by the trade with predetermined adjusted characteristics. The LSR components are paste-like and are combined by means of special pumping, metering and mixing techniques to a melding composition, which can be processed to shaped polymer parts on an injection molding machine. At an elevated temperature (at approximately 150-200° C.) LSR is a cross-linking silicone rubber, namely a so-called “high temperature cross-linking silicone rubber” (HTV silicone rubber). The cross-linking reaction of the polymer is, for example, a platinum (Pt) catalysed additive cross-linking in which a polysiloxane reacts with a cross linking agent (comprising short polymer chains) and under the influence of a Pt-catalyst. The cross linking agent and the catalyst are partial means for carrying out the crossing linking reaction and form two components of a cross linking agent.

In comparison with conventionally cross linked silicones (synthetic or natural), LSR is characterised by a high resistance to temperature and also by a good physiological tolerance which renders LSR harmless as regards hygienic requirements. The stability of LSR with respect to other mediums is, as a rule, satisfactory; however, LSR is often poorer than that of solid silicone, for example, if LSR comes into contact with petrol, fats, oils or aromatic substances.

The foaming of solid silicone and the use of this material as a molding composition is known—in contrast to an analogous processing of LSR. A chemical expanding agent is used as an additive in solid silicone as in classical silicone processing. With solid silicone the addition of additives has to be carried out in a preliminary stage, which contributes considerably to processing costs. Moreover, mold manufacturing processes using solid silicone can as a rule only be automated in part and the storage of solid silicone is less simple than that of LSR.

Chemical expanding agents have not led to success with LSR, since the thermal decay/decomposition of the expanding agent first takes place in the tool and the cross linking reaction of the LSR is much too fast for a foam of adequate quality to result.

LSR is a material which is very sensitive to shearing and dwell time. For this reason, screw conveyors are used in known injection molding processes which only transport and do not homogenise or mix. In known methods for the foam injection molding of thermoplastics (see for example EP-B-0952908), the expanding agent is added at points at one or more bores in the injection unit. In this arrangement, LSR has to be mixed intensively. If one uses this method analogously to process LSR, the intensive mixing results in shearing which starts a premature cross-linking in stagnation zones. In this way, the procedure comes to a standstill. Attempts to use the known method analogously in LSR have thus not led to success.

A batch-wise pre-charging of the LSR components with a physical expanding agent is already known (see EP-A-0 593 863). This method is not suitable for use as a part method in combination with an injection molding method. The injection molding is carried out quasi-continuously and, thus, largely or substantially continuously (with the prepared molding composition being injected into the shape giving tool intermittently, for example in cycles of 20s). In spite of the batch-wise procedure, this combined method would be possible but would be very expensive: a lot of time (in accordance with EP-A-0 593 863 at least 2 hours) and correspondingly large container volumes would be necessary. The batch-wise pre-charging is for this reason not economical and thus cannot be put into industrial practice.

The foaming of LSR would be economically advantageous for many reasons. The material characteristics of LSR depend partly on the selection of the raw materials. A characteristic spectrum of LSR can, however, only be adjusted to a limited degree by way of the raw materials. New material characteristics can be produced by means of foaming with which new fields of application can be found. Furthermore, the foaming facilitates a more efficient exploitation of raw materials. Components become lighter, a use of material more economical.

The applications which come into question are similar to those of foamed solid silicones; however, physically foamed silicones i.e. shaped polymer parts made of LSR have the additional following advantages:
adjustment of component characteristics via the manufacturing process and not via a special processing step (analogous to the addition of additives of the chemical expanding agent in the solid silicone);
higher degree of foaming, since higher concentrations of physical expanding agent are possible:
no impairing of mechanical and/or physiological characteristics by decomposition residues of a chemical expanding agent. Due to the fact that no decomposition residues remain in the polymer, a higher softness can be achieved for example.

It is also desirable to be able to manufacture physically foamed shaped polymer parts from LSR. An injection molding method is known from DE-A-198 53 021 with which foamed shaped polymer parts can be manufactured. After a suitable further development, this method can be used to also manufacture foamed shaped parts made of LSR. This special method is described in a European application (EP 4405329) which has not been prior published.

Briefly, the invention employs a method in which the manufacture of a foamed polymer body from the molding composition LSR is substantially continuous (i.e. quasi continuous).

The molding composition which has been prepared in a special way, namely impregnated with a physical expanding agent is injected into a shape-giving tool. There the cross linking reaction takes place at an elevated temperature simultaneously with the formation of small foam bubbles. Prior to its preparation, the molding composition is present in the form of two components which are kept separate, which respectively contain partial means for carrying out the cross linking reaction and which differ due to these partial means.

The two components are conveyed separately in two streams at elevated pressure at the start of the preparation. In this arrangement, at least one of the components is impregnated with the physical expanding agent. The two streams are conveyed together after the impregnation—still under raised pressure and are mixed together. Ultimately, the reactive mixture formed during the mixing is metered and injected into a cavity of the shape-giving tool with the pressure being reduced.

One object of the invention is to apply this method which has been developed further and which represents an invention to make useful shaped polymer parts from foamed LSR. Foamed shaped polymer parts such as this can be manufactured by use of the method that is more particularly described in EP 4 405 329.

The invention provides a shaped polymer part made of LSR that is manufactured by use of the method and is characterized in having a degree of foaming of 5 to 70% by volume and/or a Shore A hardness which is reduced by at least 10% in relation to a shaped polymer part made of non-foamed LSR.

The manufactured shaped polymer part forms a body which, with regard to an interaction with an activated object or with a further non-activated object, is specifically designed with regard to its physical characteristics in accordance with its purpose.

These and other objects and advantages of the invention will become more apparent from the following detailed description taken in conjunction with the accompanying drawings wherein:

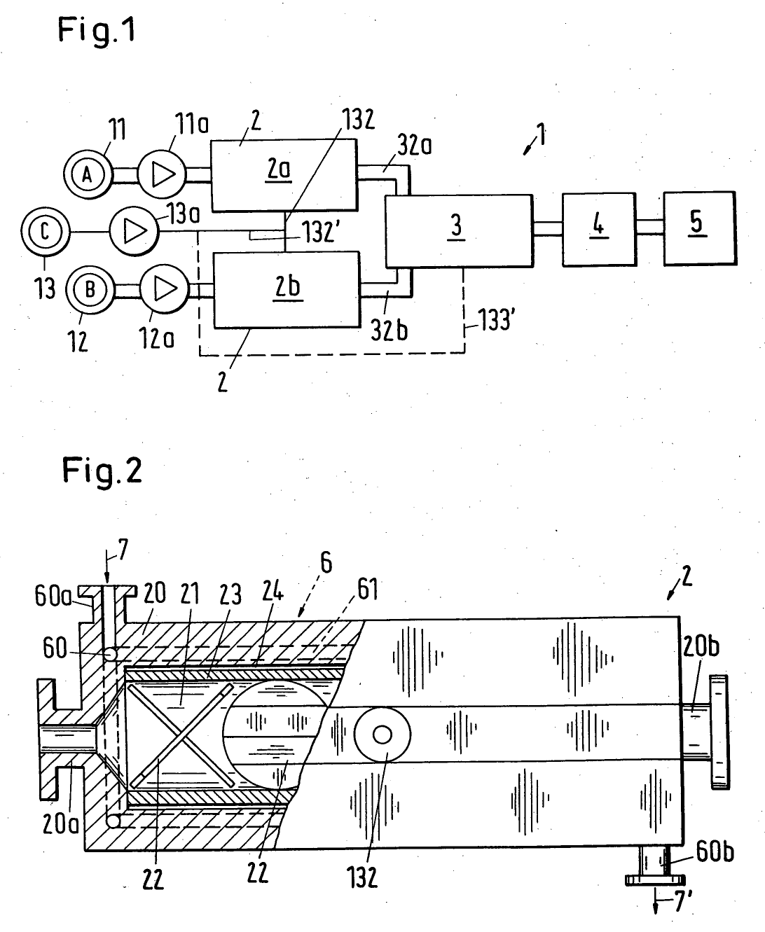

FIG. 1 illustrates a block diagram of an installation with which the method to be used can be carried out;

FIG. 2 illustrates a partially broken away longitudinal side view of an impregnating apparatus employed in the installation of FIG. 1; and

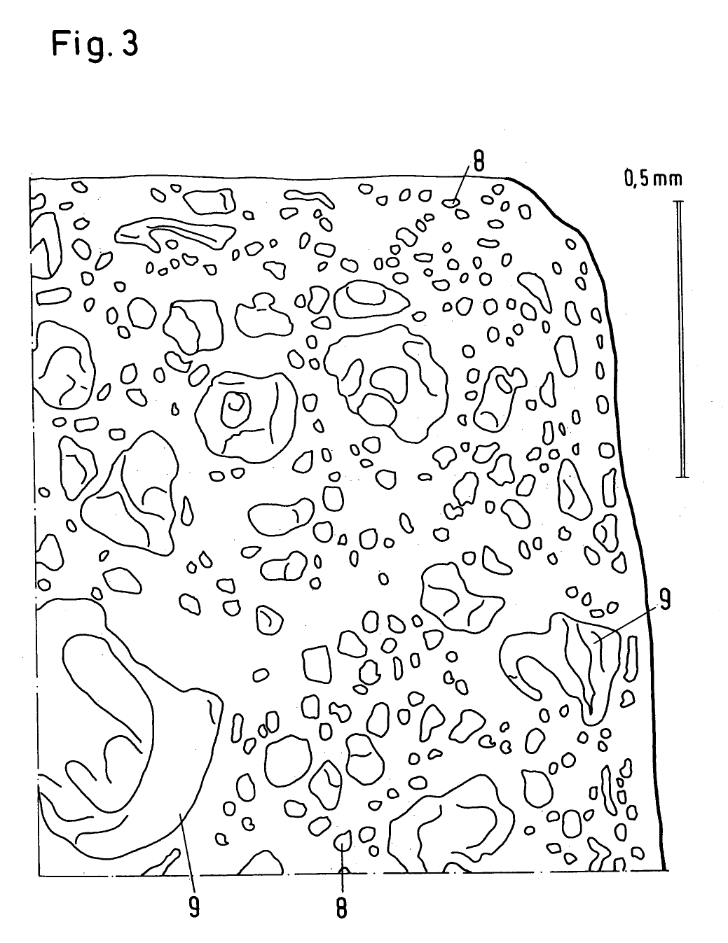

FIG. 3 illustrates a drawing made from a microscopic photograph which shows a section through a foamed LSR made in accordance with the invention.

Referring to FIG. 1, an installation 1 by which the method to be used can be carried out includes reservoirs 11, 12 for the molding composition components A and B ands a reservoir 13 for an expanding agent C. The reservoirs 11,12 for the molding composition components A,B are connected via pumps 11a, 12a with impregnating apparatuses 2a, 2b that are of like construction. Alternatively, there can also be only one impregnating apparatus. The reservoir 13 for the expanding agent C is connected via a pump 13a to each impregnating apparatus 2a, 2b to deliver the expanding agent thereto.

The installation also includes a mixing apparatus 3 connected downstream of and to the impregnating apparatuses 2a, 2b to receive the impregnated molding composition components A,B, a connection apparatus 4 and a shape-giving tool 5, such as an injection molding machine. The polymer bodies or shaped polymer parts which are to be created in accordance with the invention are foamed in the shape-giving tool 5 simultaneously with the cross-linking reaction.

In operation, the two components A and B (or only one component) are impregnated with the physical expanding agent C which is fed by the pump 13a (or compressor) out of the reservoir 13 through a line 132′ and inlet-pipe connections 132 into the impregnation apparatuses 2a, 2b. The expending agent C may be a fluid , such as carbon dioxide (CO₂), nitrogen (N₂), a hydrogen compound (for example, pentane) or a mixture of the named gases can be used as an expanding agent C.

After impregnation, the components A and B are conveyed through lines 32a, 32b into the mixing apparatus 3, where they are led together and further mixed together under elevated pressure. The resultant mixture is then fed into the connection apparatus 4 which includes a metering apparatus (not shown) and a throttle nozzle (not shown) that opens out into a cavity of the shape-giving tool 5.

Finally, the mixture is injected into the cavity of the shape-giving tool 5 while reducing the pressure. The cavity is heated to accelerate the cross-linking reaction.

Referring to FIG. 2, each impregnating apparatus 2 includes the following components: a housing 20 for a cylindrical mixing chamber 21 in which static mixer elements 22 are arranged and also connection stubs 20a, 20b for the composition to be impregnated; and a tubular wall 23 (or sleeve 23) between the interior wall of the housing 20 and the mixing chamber 21, which is manufactured from a porous material (for example, from sintered metal grains) and which defines a gap 24 with the interior wall of the housing 20.

The expanding agent C which can be fed in under pressure can be distributed homogeneously through the wall 23 over the housing surface of the mixing chamber 21. The expanding agent C, which is fed in through the stub 132, flows through the annular gap 24 tangentially and axially over the outer surface of the tubular wall 23.

A channel system 6 for a coolant is integrated into the housing 20 (indicated by arrows 7, 7′) with which heat can be extracted during impregnation from the molding composition components A and B processed by the mixing elements 22.

By the use of the described method, a shaped polymer part of foamed LSR can be manufactured which is characterized in having a degree of foaming from 5 to 70% by volume. The Shore hardness (Shore A) in relation to a shaped polymer part of non-foamed LSR can be reduced by at least 10%.

FIG. 3 shows a drawing which has been prepared from a microscopic recording. The recording shows a section through a sample of foamed LSR and shows micropores 8 and macropores 9. The cut surface shown is one to two square millimetres in size. Only the contours of the micropores 8 are shown. In the original microscopic recording (i.e. a picture), one can see different shading inside the contours—depending on the position of the section plane in relation to the position of the pores: dark shading with deep pores, light shading with shallow pores. Inner topographies resembling an ear or auricle are also suggested in the macropores 9. A peripheral part is illustrated in FIG. 3 at one corner of the sample. In an inner region of the sample, the density of the macropores 9 increases. A more regular structure, preferably a microcellular structure can be achieved by both material optimisation and also by optimisation of the process.

Microcells are cells—called pores in the above—with a diameter smaller than approximately 0.1 mm; a foam with a microcellular structure is a foam with cells the mean diameter (cell size) of which is less than 0.1 mm.

Hardness measurements (in accordance with Shore A) were made on the sample illustrated as well as on other samples of the same geometry. In this connection, reductions in the hardness were measured, which lie between 22 and 65% in dependence on the degree of foaming set. The degree of foaming can be quoted as a reduction in density. This is approximately 50% in the illustrated sample.

Various areas of use for shaped polymer parts made of foamed LSR are possible which result in an improved profitability. Individual applications may yet be made possible.

The shaped polymer part may, for example, be a handle for a piece of sporting or working equipment. In this arrangement, tactile characteristics of the foamed LSR convey a gripping sensation which advantageously stimulates the sense of touch. A pleasant gripping sensation of this kind is a “soft touch” for example. Furthermore, the friction characteristics of the gripping surface can be modified in such a way that they give a secure hold for a grasping hand.

A further embodiment is a medical prosthesis or a medical implant. Lighter and softer implants and also pads or protectors with new characteristics are possible: better damping, less impairment from the surrounding (wound) tissue. A breast implant can be manufactured in particular, wherein due to matched density, pliability and damping characteristics of the foamed LSR a good compatibility of the prosthesis arises with respect to the surrounding body tissue.

The shaped polymer part can be a comforting dummy or a bottle teat for infants or toddlers. Due to matched density, pliability and damping characteristics of the foamed LSR this article makes it possible for an infant to experience a natural biting sensation. Apart from such new material characteristics which concern the hardness, a more economical use of material results.

The shaped polymer part can also be designed as a container for household use. A container of this kind is in particular a baking mould or a freezing tray for making ice cubes in which the thermal characteristics are improved. There is also a more economic use of material.

The freshly manufactured shaped polymer part still contains disturbing monomers or other components which have not reacted. The disturbing components can be removed by means of a tempering process. The tempering time is reduced as a result of more favourable diffusion conditions in the foamed LSR.

A further example for a shaped polymer part in accordance with the invention is a damping body which is suitable for oscillation damping in an object producing noise (for example a car) or in a vibrating object (for example a ventilator).

The shaped polymer parts can also be designed in shapes which are suitable for sealing purposes or for the compensation of production tolerances. An increased softness makes new sealing concepts possible in which an improved malleability is useful.

The shaped polymer part can also be used for a printing cylinder as a tubular cover or a coating, in order to produce a technical printing surface which, for example, facilitates improved friction characteristics using less material.

The polymer can be used in the form of a composite material, in particular a nano composite material, to which electrically conducting additives are added. A shaped polymer part with metallic additives can be used as a screen against electromagnetic waves. In this arrangement, a reduction of the proportion of metal in comparison with known screens is possible. Using metallic additives, the electrical conductivity of the shaped part can be increased in order to thus prevent electrostatic charges.

Areas of use of the named conducting composite materials are, for example: antistatic treatment of plastics, antistatic packaging, electromagnetic screening, heat dissipation in microelectronics, lowering of surface resistances for safety reasons for electrical operating means in explosion endangered areas.

What is claimed is:

1. The use of a method for the manufacture of a foamed shaped polymer part with liquid silicone rubber LSR as the molding composition in which method the molding composition is present prior to processing in the form of two separate components, at the start of a preparation these components are conveyed separately in two streams under elevated pressure and in this a substantially continuous impregnation with an expanding agent is carried out in at least one of the components, after the impregnation the two streams are furthermore led together and also mixed together under elevated pressure and finally, while reducing the pressure, the reactive mixture formed during mixing is injected into a heated cavity of a shape giving tool in which the molding composition is simultaneously foamed with a cross-linking reaction, wherein
the manufactured shaped polymer part has a degree of foaming of from 5 to 70% by volume and/or
the Shore A hardness is reduced by at least 10% in relation to a shaped polymer part of non-foamed LSR and
the manufactured shaped polymer part forms a body which, with regard to an interaction with an activated object or with a further non-activated object and with regard to its physical characteristics, is designed in accordance with its purpose.

2. The use in accordance with claim 1 characterised in that the shaped polymer part is free of residues of chemical expanding agent.

3. The use in accordance with claim 1 characterised in that the shaped polymer part is a handle having tactile characteristics to convey a gripping sensation stimulating at least one of the sense of touch and modified friction characteristics for a secure hold for a grasping hand.

4. The use in accordance with claim 1 characterised in that the shaped polymer part is a breast implant having density, flexibility and damping characteristics matched to the body tissue in which the implant is to be implanted.

5. The use in accordance with claim 1 characterised in that the shaped polymer part is one of a comforting dummy and a bottle teat for toddlers and infants having density, flexibility and damping characteristics matched to a natural biting sensation.

6. The use in accordance with claim 1 characterised in that the shaped polymer part is one of a baking mold and a freezing tray for making ice cubes.

7. The use in accordance with claim 1 characterised in that the shaped polymer part is a damping element for oscillation damping in one of an object producing noise and a vibrating object.

8. The use in accordance with claim 1 characterised in that the shaped polymer part is made in a shape suitable at least for one of sealing purposes and the compensation of production tolerances.

9. The use in accordance with claim 1 characterised in that the shaped polymer part is formed as one of a tubular cover and a coating for a printing cylinder to produce a technical printing surface.

10. The use in accordance with claim i characterised in that the shaped polymer part includes metallic additives for use as at least one of a screen against electromagnetic waves and for raising the electrical conductivity of the shaped part for the prevention of electrostatic charges.

11. A method for the manufacture of a foamed shaped polymer part comprising the steps of
generating a first stream of a first molding composition component for an LSR two-component polymer system;
generating a second stream of a second molding composition component for the LSR two-component polymer system;
impregnating at least one of said streams with an expanding agent;
thereafter mixing said streams together under an elevated pressure to form a reactive mixture; and
injecting said reactive mixture under a reduced pressure from said elevated pressure into a heated cavity of a shape-giving tool for foaming of said reactive mixture therein into a shaped polymer part characterized in having at least one of a degree of foaming of from 5 to 70% by volume, a Shore A hardness reduced by at least 10% in relation to a shaped polymer part of non-foamed LSR and density, flexibility and damping characteristics matched to the end use of the shaped polymer part.

12. A shaped polymer part of foamed liquid silicone rubber characterized in having at least one of a degree of foaming of from 5 to 70% by volume, a Shore A hardness reduced by at least 10% in relation to a shaped polymer part of non-foamed LSR and density, flexibility and damping characteristics matched to the end use of the shaped polymer part.
